(19) United States
(12) Patent Application Publication
(10) Pub. No.: US 2014/0181007 A1
(43) Pub. Date: Jun. 26, 2014

(54) TRADEMARK RESERVATION SYSTEM

(71) Applicant: ONOMATICS INC, Helsinki (FI)

(72) Inventors: Mikael Kolehmainen, Helsinki (FI); Heikki Vesalainen, Vantaa (FI); Anna Ronkainen, Helsinki (FI); Matti Kokkola, Espoo (FI)

(73) Assignee: ONOMATICS INC, Helsinki (FI)

(21) Appl. No.: 13/723,241

(22) Filed: Dec. 21, 2012

(51) Int. Cl. G06F 17/30

(52) U.S. Cl. CPC G06F 17/30002
USPC 707/607

(57) ABSTRACT

A data processing system and method for assisting in searching items on Internet and to a method related to invoicing a user based on the action taken on the search results. An optimized transactional process for the selection of an appropriate parameter for action and the take decision on the basis of results obtained. For example in a robotic control, technical process control in an industrial environment, database searches and analysis in respect of trademarks, or in a control military defence hardware. The system offers a search service configured to check if a user took action on the search result it is configured to invoice the user for example, a searched new trademark was later registered by a searcher, and invoice the searcher later if the trademark was registered afterwards.

### FIELD OF THE INVENTION

The present invention relates to data processing systems for finding identical and similar elements stored in a database used for searching items on the Internet, or similar communication network on behalf of users, and for assisting with invoicing of users based on one or more actions executed by the users, based upon search results. The invention further relates to a method of using the data processing systems to search and analyze information in trademark databases. The data processing system and its associated method are beneficially employed for trademark reservation purposes, although not limited thereto.

### BACKGROUND OF THE INVENTION

A common problem faced in optimizing many industrial and electronic business processes is the selection of an appropriate parameter for action and then implementing a correct decision on the basis of results obtained. Examples of these industrial processes include robotic control, technical process control in manufacturing, database searches or in control of military defence hardware. A decision made by personnel may have a complicated dependence on various factors such as: an already available solution, heuristics, pattern, prior knowledge, and the like. In order to improve, or to optimise, the result of such a process, the process may be performed by analysing various databases. A database search involves similar problems. In this type of process, optimization methods may be used to improve a prediction as to whether or not an item in a database may have similar information to satisfy some selected criterion. An item may include a number of characteristics. A search is performed using a number of sets of test characteristics, which are varied until a sufficient number of items which match the test set satisfy the selected criterion. Those which do not match the test set should not satisfy the selected criterion. The range of possible results of a process combined with the range of possible parameters is known as the search space of the process. A difficult problem related to optimization methods and invoicing users based on the provided information exists in the space. This problem is related to the selection and generation of result sets of and the process followed thereafter.

In the following example of prior art, the data processing system is used for trademark search and registration processes. A trademark is a distinctive sign or indicator used by businesses, individuals, organizations and other legal entities for consumers to identify and distinguish their goods and services from those from other entities and signify that the products or services on or with which the trademark appears originate from a unique source, designated for a specific market. A trademark may be a name, word, phrase, logo, symbol, design, image, or a combination of these elements. There is also a range of non-conventional trademarks comprising marks which do not fall into these standard categories, such as those based on color, smell, or sound. A trademark may be designated by the following symbols: ™ (for an unregistered trade mark, that is, a mark used to promote or brand goods), ^{SM} (for an unregistered service mark, that is, a mark used to promote or brand services), ® (for a registered trademark). The term “trademark” is also used informally to refer to any distinguishing attribute by which an individual is readily identified, such as the well-known characteristics of celebrities. When a trademark is used in relation to services rather than products, it may sometimes be called a “service mark”, particularly in the United States.

Rights to a trademark are commonly, but not always, limited by legal jurisdictions. For example, the UK Intellectual Property Office accepts registrations for, and manages records of, pending and registered UK trademarks, while the US Patent & Trademark Office accepts registrations for, and manages records of, pending and registered US trademarks. There are also organizations and groupings that allow for multi-jurisdictional registration of marks; one such system is the Madrid System, and another such system is the Community Trade Mark system in the European Union.

Business, individuals, organizations and other legally-recognized entities may register a trademark with appropriate governmental or international bodies. The owner of a registered trademark may take legal action against any unauthorized use of their trademark. Most countries require formal registration of a trademark as a precondition for pursuing this type of action. A few countries, including the United States and Canada, also recognize common law trademark rights, for example for famous trademarks, which means action can be taken to protect a trademark that is in use but not registered. Generally, common law trademarks do not offer the holder as much legal protection as registered trademarks, because it is necessary to prove that the common law trademarks are well known.

Prior to trademark use and registration, a thorough search should be undertaken after a potential trademark is selected or created and determine whether or not the trademark is available for both use and federal registration. A prospective trademark user may be charged with constructive notice of any identical or confusingly similar mark that is federally registered. Beneficially, a search of trademark records should be conducted online on the PTO databases and common registry databases. A normal procedure to check if the trademark can be registered or not is to allocate substantial amount of attorney work to study existing databases to find if there is an exact match in desired service or product class or their cross-class, or if there is similar match in desired service or product class or their cross class.

Searching trademarks and registering requires monetary resources. Moreover, it takes a considerable amount of time to execute the trademark search. In particular, finding “similar” trademarks takes a long time, and costs associated with providing the service are typically high. The Internet has been playing an important role in our lives since the latter part of the 20^{th} century; a plethora of services, resources and functions that are delivered over the Internet may include databases, the delivery of requested information in various formats not limited to viz. HTML (Hypertext Markup Language), PHP, JSP, Flash, DHTML, ASP, ASPX and more. A web browser such as Apple Safari and Mozilla Firefox plays an important role in using Internet-based service (“Apple Safari” and “Mozilla Firefox” are registered trademarks). Various Internet-based search platforms offer trademark search tools such as Trademarkia.com (Trademarkia.com is a domain of LegalForce) which offers a service of checking if the trademark is a one-to-one fit in respect of a desired new trademark. A problem from the search engine provider's point of view is that there are negligible revenues generated for the provider of the service which forms the basis for the decision to file for registering the desired new trademark. A first prior art solution for this is to offer search services as transaction-based service, namely “pay as you use service”, namely invoicing per search or subscription executed, and a second prior art solution for this is to offer a flat periodic subscription, for example “pay per month” service, namely a service for executing any number of searches per month. A problem with the first solution is possibly high cost for the user in case of having a plurality of trademark options associated with a given product. If each search costs separately, the total cost can be high. A problem with the second solution, namely subscription based, for example pay per month or other time period, is that persons can misuse the service, namely execute too many searches and sell the search results forward.

Generally, trademark laws in different countries/territories set requirements that the proposed trademark has to be “sufficiently different” from existing trademarks in order to get protection for the proposed trademark. One challenge on analyzing if the trademark is new or not new is a fact that many different written words can sound alike when spoken. In addition, a small change in written format can still cause confusion if the change is too small. Examples: Apple vs Applee, or Nokia vs Mokia, or Microsoft vs Mikkisoft.

In summary, it is increasingly important to identify patterns and connections by way of the use of data processing systems accessing digital data and taking appropriate action based on the patterns identified. Moreover, the system is beneficially used to optimise a trademark registration process by providing an accurate and cost-effective search service which offers a reduced cost burden on users, for example customers.

### SUMMARY OF THE INVENTION

The present invention seeks to provide an improved and cost effective data processing system for optimizing a transactional process for selection of an appropriate parameter for action and then executing decisions on a basis of results pertaining to the parameter.

According to a first aspect of the present invention, there is provided a data processing system as defined in appended claim 1: there is provided a data processing system including an input arrangement, and data processing arrangement, a database, and an output arrangement, wherein the input arrangement is operable to receive input stimuli which are converted to a first signal for the data processing arrangement, wherein the data processing arrangement is operable to process the first signal by applying one or more rule-based filters thereto to generate one or more search elements, wherein the data processing arrangement is then operable to find identical and similar elements stored in the database as comparison elements, wherein the data processing arrangement is operable to analyze the comparison elements, by applying one or more rule-based filters thereto, in relation to the first signal to find one or more associations therebetween, and to generate a second signal for outputting via the output arrangement for invoking a response strategy from the system.

The invention is of advantage in that it optimizes a transactional process by providing faster and accurate results during the selection of an appropriate parameter for action for taking a decision on the basis of results and invoice user only after obtaining advantage of using the system.

Optionally the invention has the data processing system used in a robotic control, in a technical process control in an industrial environment, in database searches and analysis in respect of trademarks, or in control of military defence hardware. The advantages of this approach are that traditionally a decision made by personnel may have a complicated dependence on various factors such as already available solution, heuristics, pattern, prior knowledge, and the like.

The invention enables a user to optimize database search by applying one or more rule-based filters thereto to generate one or more search elements, and thereby executing very precise decisions and achieving an understanding of linking of past actions with future outcomes.

Additionally, the output arrangement includes an arrangement for debiting recipients of the second signal for data processing performed within the system enabling users to optimize costs, for example in an event that the recipients take action as a result of recommendations provided by the second signal, for example registering a trademark based upon trademark search results, or procuring military hardware based upon recommendations included in the second signal, or applying control in an industrial environment based on recommendations included in the second signal.

Optionally, the present invention is capable of communicating via a data communication network, wherein the communication network is implemented by at least one of: a wireless communication network, Internet, a distributed sensor network.

Additionally, the present invention performs an analysis of inputted trademark information, together with a report of identical and similar trademarks which exist and/or have been registered with trademark authorities a priori, Thereby, capable of reducing risk of potential trademark infringement.

Optionally, in the data processing system, the output arrangement is operable to invoice recipients of the report on a per-analysis basis or at regular temporal intervals, namely based upon information included in the second signal.

Optionally, in the data processing system, the output arrangement and/or the data processing arrangement is operable to authenticate bank details of a recipient of the second signal before sending the second signal to the recipient in response to positive authentication of bank details being achieved.

According to a second aspect of the invention, there is provided a method of operating a data processing system including an input arrangement, and data processing arrangement, a database, and an output arrangement, wherein the method includes:
(a) receiving at the input arrangement input stimuli and then converted the input stimuli to a first signal for the data processing arrangement;
(b) using the data processing arrangement to process the first signal by applying one or more rule-based filters thereto to generate one or more search elements;
(c) using the data processing arrangement to find identical and similar elements stored in the database as comparison elements;
(d) using the data processing arrangement to analyze the comparison elements, by applying one or more rule-based filters thereto, in relation to the first signal to find one or more associations therebetween, to generate a second signal for outputting via the output arrangement for invoking a response strategy from the system.

Optionally, the method includes using the data processing system to perform one or more of the following: robotic control, technical process control in an industrial environment, database searches and analysis in respect of trademarks, control military defence hardware.

Optionally, the method includes an arrangement for debiting recipients of the second signal for data processing performed within the system, for example debiting recipients depending upon recommendation information included in the second signal which the recipients act to implement.

Optionally, the method includes the input arrangement and output arrangement which are operable to communicate via a data communication network, wherein the communication network is implemented by at least one of: a wireless communication network, Internet, a distributed sensor network.

Optionally, the method includes the second signals include an analysis of inputted trademark information, together with a report of identical and similar trademarks which exist and/or have been registered with trademark authorities a priori.

Optionally, the method includes the second signal includes as assessment of risk of potential trademark infringement.

Optionally, the method includes the output arrangement is operable to invoice recipients of the second signal on a per-analysis basis or at regular temporal intervals.

Optionally, the method includes the output arrangement and/or the data processing arrangement is operable to authenticate bank details of a recipient of the second signal before sending the second signal to the recipient in response to positive authentication of bank details being achieved.

Optionally, the method can be implemented by a software product recorded on machine-readable data storage media, wherein the software product is executable upon a computing hardware.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

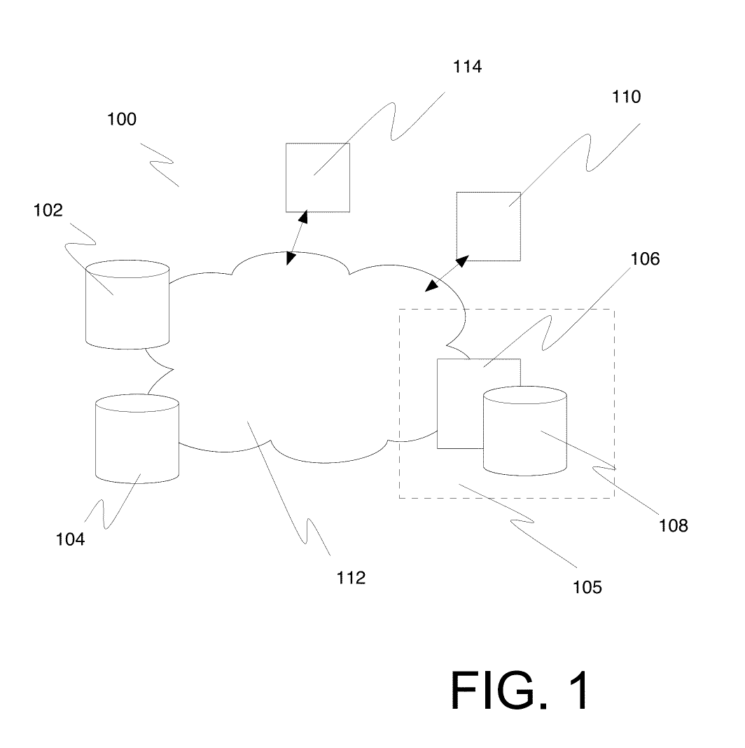

FIG. 1 is an illustration of a high level architecture of data processing system implemented pursuant to the present invention;

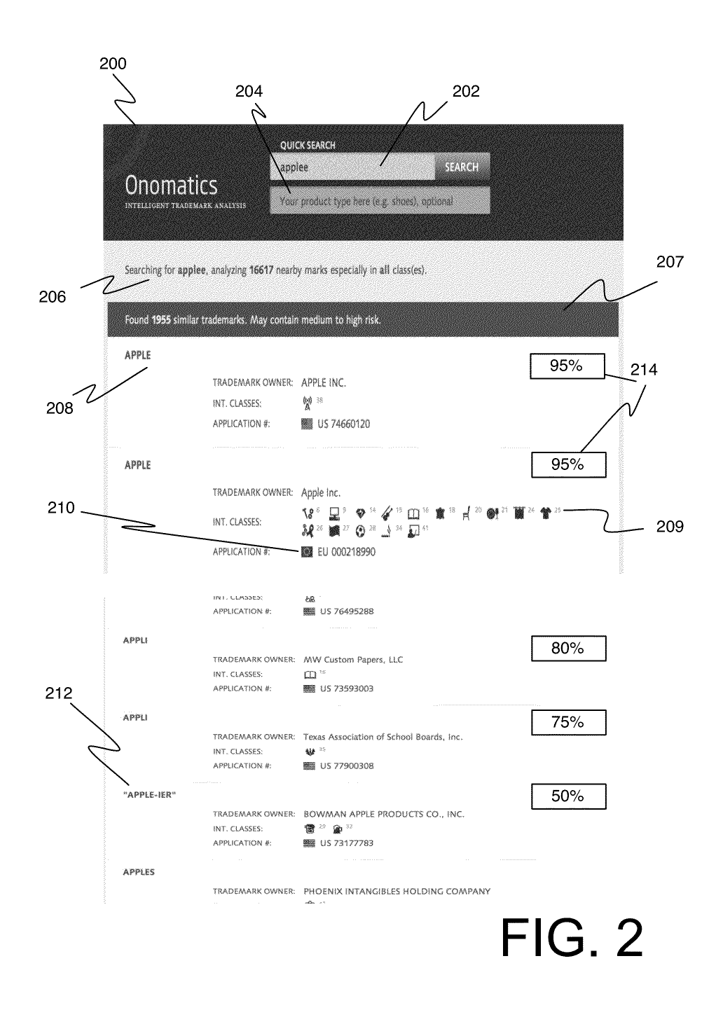

FIG. 2 is a User view of a search service;

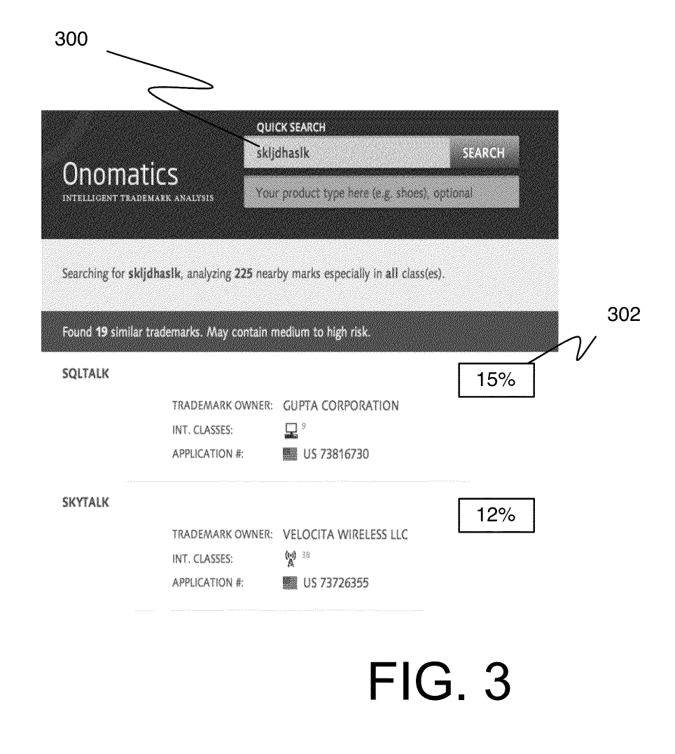

FIG. 3 is a User view of search results;

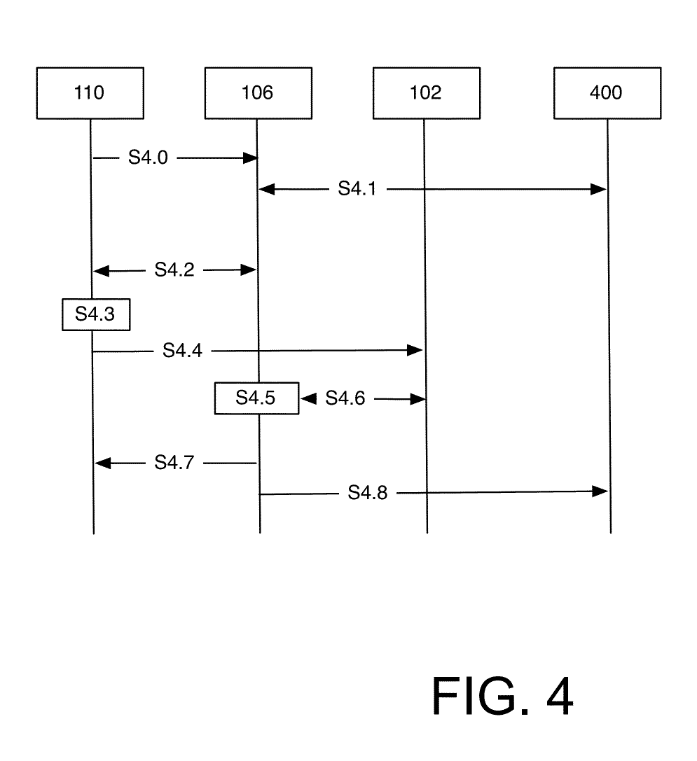

FIG. 4 is a Business model and response strategy from the system of FIG. 1; and

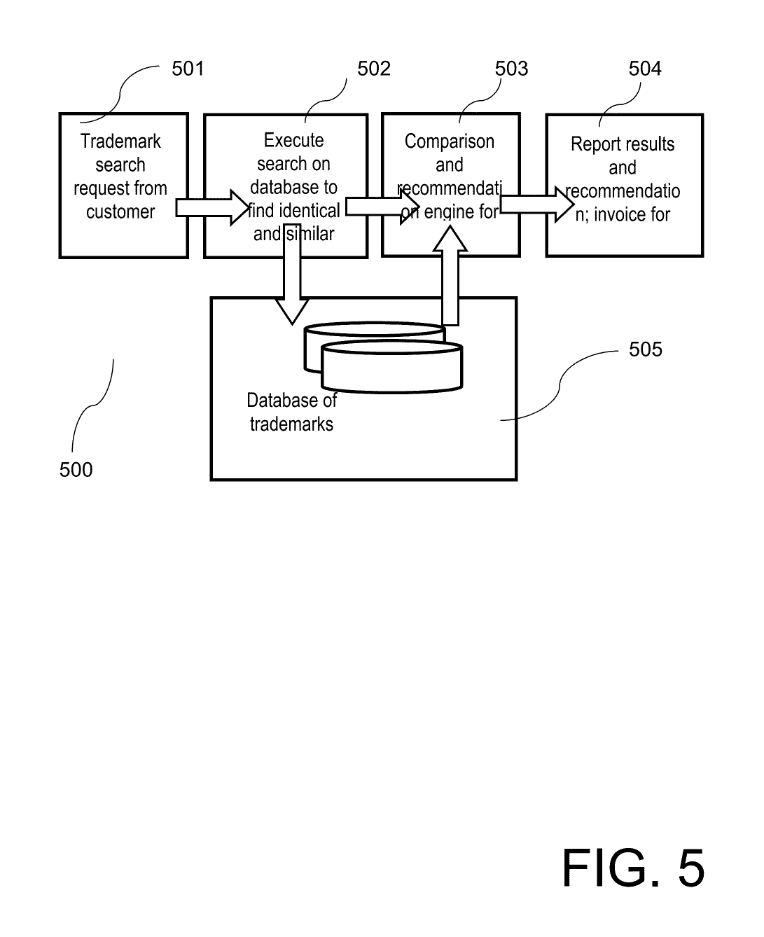

FIG. 5 is an illustration of an example data processing system used for optimising trademark search and registration process

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

Referring to FIG. 1, there is shown an illustration of a high level architecture of a data processing system 100 for executing one or more of: robotic control, technical process control in an industrial environment, control of military defence hardware, database searches and analysis in respect of trademarks, searching and reserving trademarks. By way of example, the embodiment of the analysis of trademarks will be used to describe the invention, although it will be appreciated that the present invention can be used in various industries. The data processing system 100 comprises two databases 102 and 104. The database 102 is preferably the United States Trademark and Patent Office (USPTO) database with access to all US Trademark information. The database 104 is beneficially one or more publicly-accessible trademark databases, for example the Office for Harmonization in the Internal Market (OHIM) database for Trade Marks and Designs in European Union or alternative national patent and trademark offices with similar capabilities of online trademark information.

A data processing arrangement example including a Trademark search engine 105 consists of server systems 106 which can be accommodated at a given certain location accessible via a communication network 112, such as the Internet, via Cellular operator networks, Intranets or distributed as a cloud based service. The data processing arrangement 105 optionally also includes a database 108 for storing data retrieved from other databases such as the trademark databases 102 and 104. An input, for example a customer request 110 input to the system, can use the data processing arrangement 105 via a communication network 112 with any computing device, which could include computers, laptops, tablet computers, smartphone telephones or similar. The database 108 optionally also stores data related to the customer request 110 using the data processing arrangement 105. A communication network 112 is preferably implemented by way of the Internet, although types of communication network are optionally employed, for example encrypted proprietary networks. The connection to the network 112 with computing devices can be wired or wireless, for example when using with smart phones or other wireless devices. In a given business ecosystem, there can also be third party companies 114, such as one or more attorney firms, Attorney firm, Legal Process outsourcing firm, or Consulting firm, which offer services of registering trademarks in appropriate jurisdictions. Based on embodiments, the data processing arrangement 105, such as a search engine implemented by way of the server systems 106, is configured to receive an input search request from the customer 110 as aforementioned.

Referring to FIG. 2, there is shown an illustration of a user view of the search service, wherein an example view 200 pertains when the search service is accessed via the Internet through a suitable browser. A given user can enter a proposed trademark to be searched in a search field 202. In the example, the given user enters a name “Applee”. Additionally, the given user can enter free text information about product type or service type into a field 204. A field 206 displays an execution status of the search and, for example, indicates what is being sought and analysed. In a field 207, there is provided a summary of search results. The search results can be organized in a way that a existing trademark with a highest risk of being same or similar to a desired proposed trademark is presented at the top. According to embodiments, a risk level 204 of the proposed trademark being “good”, namely that there is a “low” risk risk of similarity or confusion arising, can also be shown to the given user. For the example search, the search results indicate that “Applee” is close to “Apple” and a risk level of “high” is indicated. The risk level can be calculated using schematic analysis of the words, similarity analysis, synonym analysis, historical data on possible invalidation actions by existing trademark owners, and so forth; the analysis is beneficially rule-based, or can be implemented by a combination of rules and neural-network processing, or similar machine artificial intelligence processes. Additionally, for the risk level, goods and/or service definitions are beneficially employed. Furthermore, for the risk level, geographical territory is taken in consideration. In a field 208, there is shown a registered trademark name. Moreover, in a field 210, there is shown a symbol or name of the geographical territory where the trademark is valid. Furthermore, in a field 209 there are shown goods and/or service classes as symbols and/or as numbers. In a field 212, there are shown examples of trademarks with lower risk level, for example “Apple-ier” with an associated risk level of “medium”.

Referring to FIG. 3, a user interface of the data processing system 100 (see FIG. 1) is shown for searching for a specific work as in the case of a trademark search. In an example embodiment of the invention, a specific word “skljdhaslk” is entered, as an input trademark, by the user of the data processing system 100 into a search field 300 to perform a trademark search. The search engine implemented by way of the server systems 106 (see FIG. 1) conducts a search, by comparing the input trademark with elements stored in the databases 102, 104 (see FIG. 1). The data processing system determines similarity between the input trademark and the elements based on rules derived from parameters of the input trademark which may include, but not limited to: shape, description, semantics, and so forth. The rules based on the parameters are used to compare trademarks and retrieve similar trademarks, represented by the elements, from the databases; such retrieval is optionally achieved using meta-data search analysis. The trademarks identified as being the most similar are ranked based on the closeness or similarity of the parameters with the input trademark; such “closeness” or “similarity” enables aforementioned risk factors to be computed. In this search, results show only nineteen “similar trademarks” being found from a set of two hundred and twenty five nearby or similar trademarks. The risk level 302, in this example, also seems to be “low”. The given user then decides to proceed to file an application for registration of the proposed trademark.

In the embodiment described above, the user most often has an existing relationship with the trusted attorney 114, see FIG. 1, namely the given user contacts the attorney and asks to register the trademark “skljdhaslk” at the USPTO. The attorney 114 registers the trademark and sends a corresponding invoice to the given user.

Referring next to FIG. 4, the communication and signalling flow of the processing system 100 are shown. The flow corresponds to a method and response strategy employed within the system. In a step S4.0, a customer 110 for the search service 106 registers as a given user of the service. The registration can include, for example, entering credit card numbers or can include other authentication methods to be used later for invoicing purposes. Preferably, registration can include asking the given user to fill a web form with company details, address, invoicing address, contact information and so forth. In a Registration step S4.0, the step includes typically also acceptance of terms and conditions of the service. Based on the method, terms and conditions state that if the customer later decides to register the searched trademark, or trademark closely related to that which is searched, the customer is invoiced. In a step S4.1, the search engine service provider can check, for example, from a credit card issuer 400 if the credit card is valid. Alternatively, in a step S4.1, some other authenticating means, for example bank authentication, can be implemented. In a step S4.2, the user/customer 110 uses the service 106. According to embodiments, the method is implemented such that the type of user is a non-limited, namely all types of users are permitted to use the service offering to the end user. Alternatively, there can optionally be restrictions on using the search for certain defined periods of time. In a step S4.3, the user may wait for a while before making the decision to file trademark at the trademark office 102, for example the USPTO, for example the actual filing can be implemented by the user or by third party.

In steps S4.5 and S4.6, the search engine service updates the databases of the search service. In case of finding new same or highly similar trademarks to that which was earlier searched by the customer 110 and found to be registered to the customer 110, or registered by the customer as a representative in a situation that the customer is an attorney company, the system in a step S4.7 sends an invoice to the customer 110, or alternatively sends a request for funds in a step S4.8 to credit card issuer 400. The business model is based on the fact that the searched item is unique and it can be traced back, in an event that customer has taken actions related to protecting the searched trademark.

Referring to FIG. 5, In an alternative embodiment of the invention, a trademark search and registration platform is denoted by 500. After receiving one or more inputs 501, 502 including a proposed trademark, a search engine analyses the proposed trademark in respect of existing trademark databases 505. The search engine 502 is configured to analyze trademarks and goods and services to find similarities therebetween. Moreover, according to the present invention, the search service is configured to check at a later time instant if the searched proposed trademark has been registered by the searcher 503. If the trademark has been registered later, the system is configured to invoice the searcher 504. The output arrangement in the system invoices the users 504 on a per-analysis basis or at regular temporal intervals by authenticating bank details using known methods. Such a platform 500 is capable of decreasing the administration required for the business and saves time and money as it helps in avoiding costs on searches performed for duplicate and similar trademarks and avoiding prosecution fees, a potential infringement in future. The platform 500 thus represents an enhancement in technical efficiency.

In an alternative embodiment, the data processing system 100 can be employed, in a business model, to give access to perform searches for attorney companies. Based on the business model, the attorney companies pay per verified filing by the attorney company, namely in an event that a trademark search engine has been used to analyze a trademark that was later filed by the attorney company, the attorney company is invoiced.

In an alternative embodiment, the present invention can be applied to any items with are uniquely identified for example domain names, social network names, for example Facebook, Twitter, and similar, and unique sellable items both digital and physical. Facebook and Twitter are registered trademarks.

In an alternative embodiment, the system 100, see FIG. 1, can be used in a robotic control, in technical process control in an industrial environment, in database searches and analysis in respect of warehouse database logistics analysis, or in a control military defence hardware during a decision making process. This system 100 is capable of improving and optimizing the result of the process. The process may be performed analysing various databases. A database search involves similar problems. In this type of process, optimization methods may be used to improve a prediction as to whether or not an item in a database may have similar information to satisfy some selected criterion. An item may include a number of characteristics. A search is performed using a number of sets of test characteristics, which are varied until a sufficient number of items which match the test set satisfy the selected criterion. Those which do not match the test set should not satisfy the selected criterion. The range of possible results of a process combined with the range of possible parameters is known as the search space of the process. A difficult problem related to optimization methods and invoicing users based on the provided information exists in the space. This problem is related to the selection and generation of result sets of and the process followed thereafter.

In an alternative embodiment, the present invention can be applied in optimising military systems. The data processing system 100 comprises databases with weapon information. The database is internally maintained or collection of databases shared between the militaries departments, or friendly nations. The data processing system can be used to uniquely identify for example weapons, intelligence systems enabling accurate due diligence prior to buying or developing a weapon or system. The data processing system enables a user view of the searched item. A given user can enter a weapon image or name in a search field. Additionally, the given user can enter free text information about weapons into a field. The field displays an execution status of the search and, for example, indicates what is being sought and analysed providing a summary of search results. Search results can be organized in a way that the weapon with highest risks of being same or similar to a earlier developed weapon system is presented at the top. This enables an efficient management of defence purchases and development by avoiding monetary and resource loss.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A data processing system including an input arrangement, and data processing arrangement, a database, and an output arrangement, wherein the input arrangement is operable to receive input stimuli which are converted to a first signal for the data processing arrangement, wherein the data processing arrangement is operable to process the first signal by applying one or more rule-based filters thereto to generate one or more search elements, wherein the data processing arrangement is then operable to find identical and similar elements stored in the database as comparison elements, wherein the data processing arrangement is operable to analyze the comparison elements, by applying one or more rule-based filters thereto, in relation to the first signal to find one or more associations therebetween, and to generate a second signal for outputting via the output arrangement for invoking a response strategy from the system.

2. A data processing system as claimed in claim 1, wherein the data processing system is adapted to perform one or more of the following: robotic control, technical process control in an industrial environment, database searches and analysis in respect of trademarks, control military defence hardware.

3. A data processing system as claimed in claim 1, wherein the output arrangement includes an arrangement for debiting recipients of the second signal for data processing performed within the system.

4. A data processing system as claimed in claim 3, wherein the recipients are debited based upon one or more actions executed by the recipients as a function of information included within the second signal.

5. A data processing system as claimed in claim 1, wherein the input arrangement and output arrangement are operable to communicate via a data communication network, wherein the communication network is implemented by at least one of: a wireless communication network, Internet, a distributed sensor network.

6. A data processing system as claimed in claim 1, wherein the second signals include an analysis of inputted trademark information, together with a report of identical and similar trademarks which exist and/or have been registered with trademark authorities a priori.

7. A data processing system as claimed in claim 6, wherein the second signal includes as assessment of risk of potential trademark infringement.

8. A data processing system as claimed in claim 1, wherein the output arrangement is operable to invoice recipients of the second signal on a per-analysis basis or at regular temporal intervals.

9. A data processing system as claimed in claim 1, wherein the output arrangement and/or the data processing arrangement is operable to authenticate bank details of a recipient of the second signal before sending the second signal to the recipient in response to positive authentication of bank details being achieved.

10. A method of operating a data processing system including an input arrangement, and data processing arrangement, a database, and an output arrangement, wherein the method includes:
(a) receiving at the input arrangement input stimuli and then converted the input stimuli to a first signal for the data processing arrangement;
(b) using the data processing arrangement to process the first signal by applying one or more rule-based filters thereto to generate one or more search elements;
(c) using the data processing arrangement to find identical and similar elements stored in the database as comparison elements;
(d) using the data processing arrangement to analyze the comparison elements, by applying one or more rule-based filters thereto, in relation to the first signal to find one or more associations therebetween, to generate a second signal for outputting via the output arrangement for invoking a response strategy from the system.

11. A method as claimed in claim 10, wherein the method includes using the data processing system to perform one or more of the following: robotic control, technical process control in an industrial environment, database searches and analysis in respect of trademarks, control military defence hardware.

12. A method as claimed in claim 10, wherein the output arrangement includes an arrangement for debiting recipients of the second signal for data processing performed within the system.

13. A method as claimed in claim 10, wherein the method includes debiting the recipients based upon one or more actions executed by the recipients as a function of information included within the second signal.

14. A method as claimed in claim 10, wherein the input arrangement and output arrangement are operable to communicate via a data communication network, wherein the communication network is implemented by at least one of: a wireless communication network, Internet, a distributed sensor network.

15. A method as claimed in claim 10, wherein the second signals include an analysis of inputted trademark information, together with a report of identical and similar trademarks which exist and/or have been registered with trademark authorities a priori.

16. A method as claimed in claim 15, wherein the second signal includes as assessment of risk of potential trademark infringement.

17. A method as claimed in claim 10, wherein the output arrangement is operable to invoice recipients of the second signal on a per-analysis basis or at regular temporal intervals.

18. A method as claimed in claim 10, wherein the output arrangement and/or the data processing arrangement is operable to authenticate bank details of a recipient of the second signal before sending the second signal to the recipient in response to positive authentication of bank details being achieved.

19. A software product recorded on machine-readable data storage media, wherein the software product is executable upon computing hardware for implement a method as claimed in claim 10.
